(19) United States
(12) Patent Application Publication
(10) Pub. No.: US 2011/0127242 A1
(43) Pub. Date: Jun. 2, 2011

(54) METHODS FOR LASER SCRIBING AND SEPARATING GLASS SUBSTRATES

(76) Inventor: Xinghua Li, Horseheads, NY (US)

(21) Appl. No.: 12/627,172

(22) Filed: Nov. 30, 2009

(51) Int. Cl. B23K 26/00

(52) U.S. Cl. 219/121.69

(57) ABSTRACT

A method of forming a scribe line in a glass substrate having a compressive surface layer and an inner tension layer includes forming a defect through the compressive surface layer that is offset from a first edge of the glass substrate. The defect extends through the compressive surface layer to partially expose the inner tension layer. A scribe line is generated through the compressive surface layer by translating the glass substrate with respect to a laser beam and a cooling jet. The scribe line is initiated at the defect and is terminated at a termination location along the scribe line that is offset from a second edge of the glass substrate.

### BACKGROUND

1. Field

The present specification generally relates to methods for separating glass substrates and, more specifically, to methods for forming scribe lines to separate glass substrates.

2. Technical Background

Thin glass substrates have a variety of applications in consumer electronic devices. For example, glass substrates may be used as cover sheets for LCD and LED displays incorporated in mobile telephones, display devices such as televisions and computer monitors and various other electronic devices. Cover sheets used in such devices may be formed by sectioning or separating a large glass substrate into a plurality of smaller glass substrates using various laser cutting techniques. For example, glass substrates may be separated by scribe-and-break techniques. However, when the scribe-and-break techniques are utilized to separate strengthened glass such as ion-exchanged glass, uncontrollable full-body separation rather than the formation of a scribe line may occur. The uncontrolled separation generally leads to poor edge characteristics compared to the scribe and break process. Moreover, full-body separation of the substrate along the line of separation prevents the formation of additional, intersecting vents in a single glass substrate.

Accordingly, a need exists for alternative methods for forming scribe lines and separating glass substrates.

### SUMMARY

In one embodiment, a method of forming a scribe line in a glass substrate having a compressive surface layer and an inner tension layer includes forming a defect offset from a first edge of the glass substrate. The defect goes through the compressive surface layer to partially expose the inner tension layer. A scribe line is generated through the compressive surface layer by translating the glass substrate with respect to a laser beam and a cooling jet. The scribe line is initiated at the defect and is terminated at a termination location along the scribe line that is offset from a second edge of the glass substrate.

In another embodiment, a method of forming a scribe line in a glass substrate includes forming a defect on a surface of the glass substrate that is offset from a first edge of the glass substrate and generating a scribe line on the surface of the glass substrate between the defect and a termination location that is offset from a second edge of the glass substrate by translating the glass substrate with respect to a laser beam and a cooling jet. The laser beam may be configured to generate an elliptical beam spot having a major axis and a minor axis on the surface of the glass substrate such that the major axis is aligned with a glass substrate cutting axis. The cooling jet may be applied to the surface of the glass substrate proximate a trailing edge of the major axis of the elliptical beam spot.

In yet another embodiment, a method of separating a glass substrate having a compressive surface layer and an inner tension layer includes forming a defect through the compressive surface layer that is offset from a first edge of the glass substrate. The defect partly exposes the inner tension layer. The method further includes applying a first laser shield to a first shielded region of the glass substrate located between the first edge and the defect and applying a second laser shield to a second shielded region of the glass substrate located between a second edge of the glass substrate and a termination location that is offset from the second edge. The first and second laser shields are operable to prevent the laser beam from being incident on the compressive surface layer in the first and second shielded regions. A scribe line is generated through the compressive surface layer by translating the glass substrate with respect to a laser beam and a cooling jet. The glass substrate may be separated along the scribe line by applying a force to the glass substrate.

Additional features and advantages of the methods will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a perspective view of an off-edge defect, an elliptical beam spot of a laser beam, and a cooling spot of a cooling jet incident on a glass substrate according to at least one embodiment of the method for forming a scribe line in a glass substrate shown and described herein;

FIG. 2 schematically depicts a cross section of the laser beam, cooling jet, and glass substrate of FIG. 1 according to at least one embodiment of the method for forming a scribe line in a glass substrate shown and described herein;

FIG. 3 schematically depicts the relative positioning of the elliptical beam spot and cooling spot according to at least one embodiment of the method for forming a scribe line in a glass substrate shown and described herein;

FIG. 4 schematically depicts a perspective view of a completed scribe line according to at least one embodiment of the method for forming a scribe line in a glass substrate shown and described herein;

FIG. 5 schematically depicts a perspective view of laser shields on a surface of a glass substrate according to at least one embodiment of the method for forming a scribe line in a glass substrate shown and described herein;

FIG. 6 schematically depicts a top view of a plurality of off-edge defects and desired lines of separation in a first direction according to at least one embodiment of the method for forming a scribe line in a glass substrate shown and described herein; and

FIG. 7 schematically depicts a top view of a plurality of off-edge defects and desired lines of separation in a first direction and second direction according to at least one embodiment of the method for forming a scribe line in a glass substrate shown and described herein.

### DETAILED DESCRIPTION OF THE PREFERRED EMBODIMENTS

Reference will now be made in detail to various embodiments of the method for forming scribe lines configured as vents extending partially through the thickness of glass substrates, examples of which are illustrated in the accompanying drawings. Whenever possible, the same reference numerals will be used throughout the drawings to refer to the same or like parts. As described herein, methods for forming a scribe line in a glass substrate generally comprise forming a defect through a compressive surface layer such that the defect is offset from a first edge of the glass substrate. An exposed inner tension layer below the compressive layer of the glass facilitates vent initiation during the laser scribing process. A beam spot of a laser source is then directed onto the compressive layer along a desired line of separation. A cooling spot of a cooling jet is directed onto the compressive layer such that the cooling spot is positioned proximate the trailing edge of the beam spot. The cooling spot and the beam spot are then advanced along the desired line of separation by translating the laser source and cooling jet, or by translating the glass substrate until the beam spot is positioned at a termination location that is offset from a second edge of the glass substrate, thereby forming a vent extending partially through the thickness of the glass substrate. The formed scribe line extends from the offset defect to the terminal location. By creating a scribe line that does not extend from a first edge to a second edge, uncontrollable full-body vents may be prevented such that the glass substrate may be later separated by mechanical means along the scribe line. Various embodiments of the methods for forming scribe lines in glass substrates as well as methods for separating glass substrates into a plurality of pieces will be described in more detail herein.

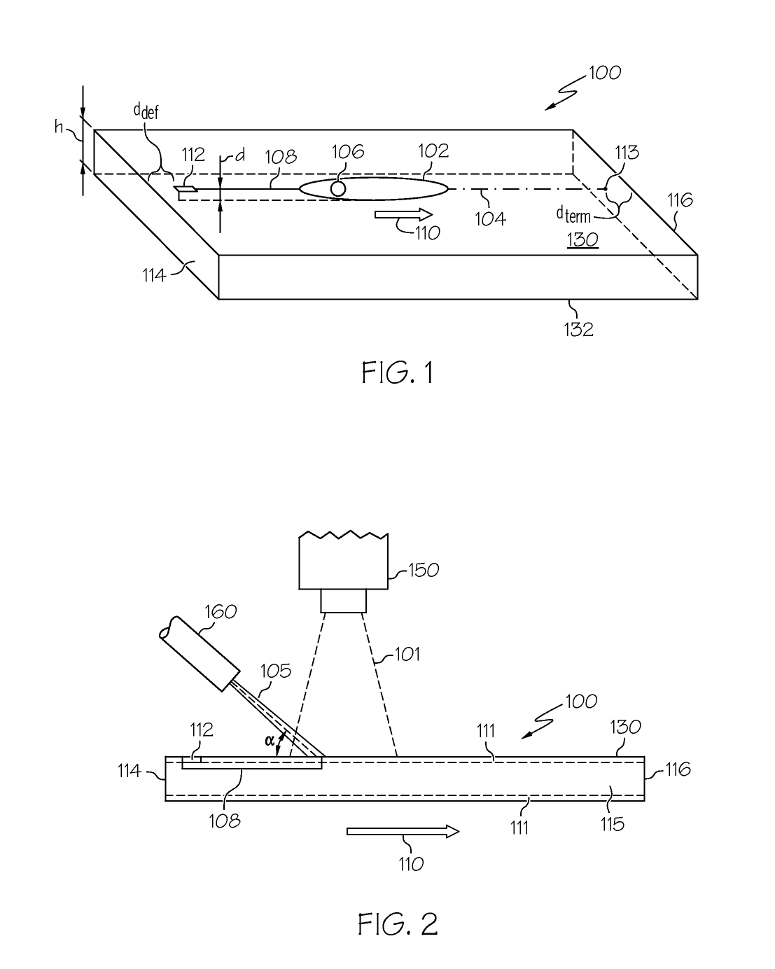

Referring to FIGS. 1, 2 and 4, an exemplary system for forming a controlled crack or vent 108 extending partially through the thickness of a glass substrate 100 is schematically depicted. The system generally comprises a laser source 150 for heating the glass substrate 100 along a desired line of separation 104 and a nozzle 160 for directing a cooling jet 105 for quenching the heated surface of the glass substrate 100 along the desired line of separation 104. The resulting change in temperature of the glass substrate due to the application of the beam spot 102 and cooling spot 106 causes tensile stresses to develop along the desired line of separation 104 in a direction perpendicular to the desired line of separation 104 thereby forming a vent 108 which extends partially through the thickness of the glass substrate 100. The vent 108 defines the scribe line 109 along the desired line of separation 104 along which the glass substrate 100 may be separated by the application of mechanical force. As described in more detail below, the scribe line 109 is initiated at a defect 112 that is offset from a first edge 114 of the glass substrate 100 and terminates at a termination location that is offset from a second edge 116 of the glass substrate 100.

In the embodiments described herein, the glass substrate 100 has a first surface 130, a second surface 132, edges (e.g., first edge 114 and second edge 116) and a thickness h. The glass substrate may be chemically strengthened by an ion-exchange process to produce compressive surface layers 111 and an inner tension layer 115 within the glass substrate. The glass substrate may be formed from various glass compositions including, without limitation, borosilicate glasses or aluminosilicate glasses, including ion-exchanged borosilicate and aluminosilicate glasses.

The laser source 150 is operable to emit a beam having a wavelength suitable for imparting thermal energy to the glass substrate 100 such that the laser energy is strongly absorbed through the glass thickness h thereby heating the surface of the glass substrate. For example, the laser source 150 generally emits a beam 101 having a wavelength in the infrared range. Suitable laser sources include a CO laser with a wavelength from about 5 μm to about 6 μm, a HF laser with a wavelength from about 2.6 μm to about 3.0 μm, or an erbium YAG laser with a wavelength of about 2.9 μm. In the embodiments describe herein, the laser source is a CO₂ laser which produces a beam of infrared light having a wavelength from about 9.4 μm to about 10.6 μm. The CO₂ laser source may be an RF-excited laser source operated in quasi-continuous wave mode. In one embodiment, the laser source 150 is operated to produce an output beam in the TEM₀₀ mode such that the beam 101 of the laser source 150 has a Gaussian intensity distribution. Alternatively, the laser source may be operated to produce an output beam in the TEM₀₁ mode such that the output beam has a “D” or flat mode intensity distribution. The output power of the laser source may be from about 20 watts to greater than 500 watts depending on the desired scribing speed, the composition of the glass being scribed, and the depth of the compressive surface layer.

In order to avoid overheating the surface of the glass substrate 100 (which may lead to ablation or vaporization of glass from the surface of the glass substrate or residual stresses which weaken the cut edge), the beam 101 emitted by the laser source may be shaped with various optical elements (not shown) such that the beam 101 has an elliptical beam spot 102 on the surface of the glass substrate 100. For example, in one embodiment, a pair of cylindrical lenses (not shown) is disposed in the path of the beam 101 emitted from the laser source 150. Alternatively, the cylindrical lenses and/or other optical elements used for shaping the beam to form an elliptical beam spot are integral with the laser source 150. The cylindrical lenses shape the beam 101 such that the beam spot incident on the surface of the glass substrate is generally elliptical in shape, as depicted in FIG. 1. Although beam spots described herein may be elliptical in shape, it should be understood that embodiments are not limited thereto as the beam spot may have other shapes including circular, square, rectangular, etc.

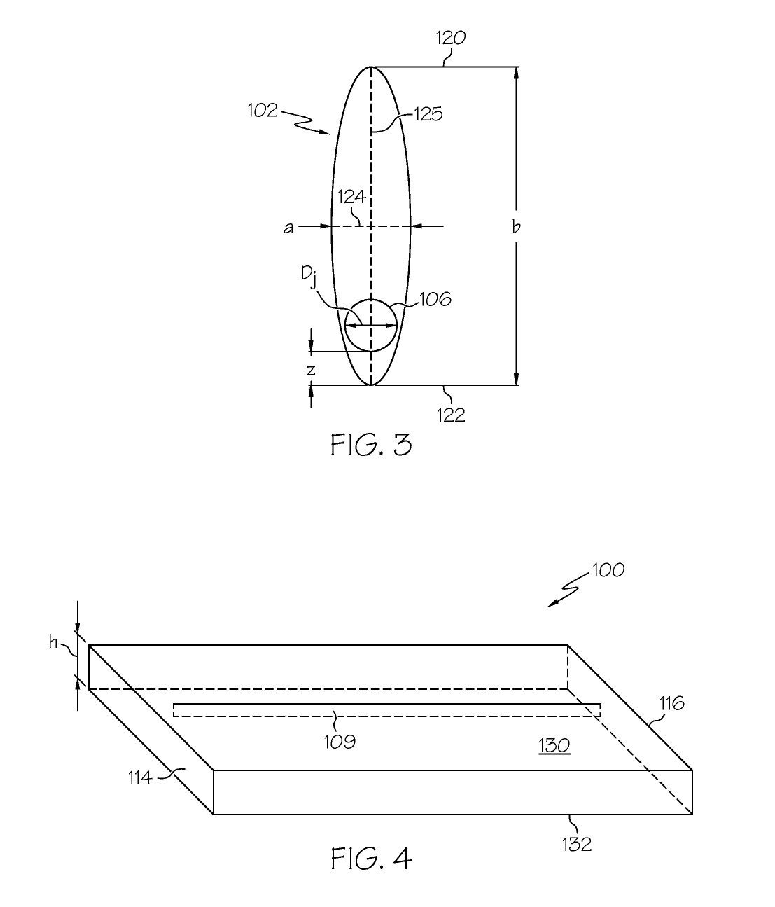

Referring to FIG. 3, the elliptical beam spot 102 generally has a minor axis 124 of length a and a major axis 125 of length b. The minor axis 124 extends across the midpoint of the elliptical beam spot as shown in FIG. 3. In one embodiment, the length a of the minor axis 124 is greater than or equal to a diameter of the cooling spot 106 formed where the cooling jet contacts a surface of the glass substrate. For example, if the cooling spot (i.e., the cross section of the cooling jet where the cooling jet is incident on the surface of the glass substrate) has a diameter of 2 mm, then the length a of the minor axis is at least 2 mm.

The major axis 125 generally has a length b between the leading edge 120 and the trailing edge 122 of the elliptical beam spot, as shown in FIG. 3. In the embodiments described herein, the beam 101 of the laser source 150 is shaped such that the length b≦ν·τ, where υ is the rate at which the elliptical beam spot and cooling jet are advanced along the scribe line and τ is the heat diffusion time through the thickness of the glass substrate.

Referring to FIGS. 2 and 3, the cooling jet 105 generally comprises a flow of pressurized fluid emitted from a nozzle 160 and directed onto the surface of the glass substrate 100. The pressurized fluid may comprise a liquid, such as, for example, water, ethanol, liquid nitrogen and/or a chemical coolant. Alternatively, the cooling jet 105 may comprise a compressed gas such as, for example, compressed air, compressed nitrogen, compressed helium or a similar compressed gas. The cooling jet may also comprise a mixture of liquid and compressed gas. In the embodiments described herein the cooling jet is de-ionized water.

The cooling jet 105 is emitted from an orifice (not shown) in the end of the nozzle. The cooling spot 106 formed where the cooling jet is incident on the surface of the glass substrate has a diameter Dⱼ which is larger than the orifice in the nozzle 160. The nozzle 160 is positioned behind the laser source 150 with respect to the scribing direction 110 (i.e., a cutting axis). In the embodiments described herein, the nozzle 160 is oriented at an angle with respect to the surface 130 of the glass substrate 100 such that the cooling jet 105 is incident on the surface of the glass substrate at an angle α which is less than 90 degrees relative to the surface of the glass substrate. In one embodiment, the cooling jet 105 may be translated in coordination with the translating beam spot 102. In another embodiment, the glass substrate 100 may be mounted on a translation table capable of translating the glass substrate 100 under the beam 101 and cooling jet 105.

Referring to FIGS. 1, 2 and 4, the method of forming a scribe line comprising a vent extending partially through the thickness h of a glass substrate 100 may include first introducing a defect 112 on a first surface 130 (i.e., the surface of the compressive surface layer 111) of the glass substrate 100 to form a scribe line initiation point. The defect 112 is offset from the first edge 114 of the glass substrate by a defect offset distance d_{def}. The defect 112 may be an initiation crack that is formed mechanically, such as with a mechanical scribe, or by laser ablation, for example. The offset distance d_{def} may depend on the desired scribing speed, the composition of the glass being scribed, and the depth of the compressive surface layer 111. In one embodiment, the offset distance d_{def} is approximately 6 mm. In other embodiments, the offset distance may be in the range of about 3 mm to about 10 mm.

After the defect 112 is formed, a beam 101 from the laser source 150 is directed onto the surface of the glass substrate 100 such that the beam is incident on the desired line of separation 104 at the defect 112. The beam is initially directed onto the substrate such that the defect 112 is positioned within the elliptical beam spot 102 of the beam 101 and the major axis 125 of the elliptical beam spot 102 is substantially collinear with the desired line of separation 104. When the beam of the laser source 150 is positioned on the surface 130 of the glass substrate 100, the beam imparts radiant thermal energy to the compressive surface layer 111 thereby heating the glass substrate along the desired line of separation 104. The maximum temperature Tₘₐₓ to which the glass surface is heated is generally less than the strain point of the glass T_{g} so as to avoid stress relaxation during heating and the development of undesirable residual stresses following quenching by the cooling jet. The temperature of the glass substrate may be controlled by adjusting various parameters including, for example, the power of the laser source and the scribing speed υ with which the beam of the laser is advanced over the surface of the glass substrate along the desired line of separation. After the beam 101 is initially positioned on the desired line of separation 104, the elliptical beam spot 102 is advanced along the surface 130 of the glass substrate 100 on the desired line of separation 104 at the scribing speed υ until reaching the termination location 113 that is offset from the second edge 116, thereby heating the surface of the glass substrate along the desired line of separation 104 between the defect 112 and the termination location 113. The elliptical beam spot may be translated over the surface by moving the laser source 150 relative to the glass substrate 100. Alternatively, the elliptical beam spot may be translated by moving the glass substrate 100 relative to the laser source 150 and nozzle 160. In either embodiment, the scribing direction 110 is as indicated in FIGS. 1 and 2.

In order to form a vent 108 in the surface 130 of the glass substrate, the heated surface of the glass substrate is cooled or quenched with the cooling jet 105 emitted from the nozzle 160. The change in temperature due to quenching causes tensile stresses to develop in the surface of the glass substrate in a direction perpendicular to the desired line of separation 104. These tensile stresses cause the vent 108 to initiate from the off-edge defect 112 and propagate along the surface of the glass substrate in the scribing direction 110 on the desired line of separation 104 and stop proximate the termination location 113 prior to the second edge 116. The termination location 113 may be offset from the second edge 116 by a termination distance dₜₑᵣₘ. In the embodiments described herein, the vent 108 may extend beneath the surface of the substrate to a depth d which is less than a quarter of the thickness h of the glass substrate. In one embodiment, the depth d is approximately 15% of the thickness h of the glass substrate. In order to initiate and propagate the vent 108 along the surface of the glass substrate, a threshold change in temperature ΔT_{TH} should be exceeded by the heating and subsequent cooling of the surface of the glass substrate in order to generate tensile stresses sufficient for vent initiation and propagation.

More specifically, heating the glass substrate with the laser source 150 and quenching the heated surface of the glass substrate with the cooling jet 105 generates a tensile stress in the surface of the glass substrate perpendicular to the desired line of separation 104. If the tensile stress exceeds the threshold tensile stress σ_{TH} of the material from which the glass substrate 100 is formed, a crack or vent 108 forms in the glass substrates.

The cooling spot 106 may be located proximate the trailing edge 122 of the elliptical beam spot 102. Referring to FIGS. 1-3, in one embodiment described herein, the nozzle 160 is oriented such that the cooling spot 106 is positioned on the surface 130 of the glass substrate 100 on the desired line of separation 104 and within the elliptical beam spot 102. More specifically, the nozzle 160 of the illustrated embodiment is oriented such that the cooling spot 106 is located within the elliptical beam spot 102 between the center of the elliptical beam spot and the trailing edge 122 of the elliptical beam spot such that the cooling spot is spaced apart from the trailing edge by a distance z, as shown in FIG. 3. In this position the cooling spot 106 is at or near the maximum temperature on the surface of the glass substrate due to heating by the laser source. Accordingly, because the glass substrate is quenched by the cooling jet at or near the maximum temperature, the resulting change in temperature ΔT (assuming the glass surface is heated to just below the strain temperature T_{g}) exceeds the change in temperature threshold ΔT_{TH} thereby facilitating the formation of the vent 108 which initially propagates from the defect 112. Although FIGS. 1-3 illustrate the cooling spot located within the elliptical beam spot and separated by a distance z, the cooling spot may be located directly on the trailing edge 122 or partially outside of the elliptical beam spot proximate the trailing edge, or lagging behind the elliptical beam spot by several millimeters.

Referring to FIGS. 1, 2 and 4, after the cooling jet 105 and cooling spot 106 are properly oriented with respect to the elliptical beam spot 102, the cooling jet and laser source are advanced along the surface 130 of the glass substrate 100 on the desired line of separation 104 in the scribing direction 110 starting at the defect 112 and terminating at the termination location 113. As the surface of the glass substrate is heated to the maximum temperature and quenched at or near the maximum temperature, the vent 108 is propagated from the defect 112 to the termination location 113 along the desired line of separation 104, thereby forming a scribe line 109 (FIG. 4). The cooling jet/laser source and the glass substrate 100 are advanced relative to one another at a scribing speed υ which, in turn, is the minimum speed of vent propagation along the desired line of separation 104. The scribing speed υ is generally selected such that overheating of the surface of the glass substrate is avoided while still allowing the surface of the glass substrate to be heated to just below the strain temperature of the glass. Ensuring that scribe line 109 extends between the defect and the termination location and not from the first edge to the second edge prevents an uncontrollable full-body vent from propagating and destroying the glass substrate 100. Following formation of the vent 108 and scribe line 109, a bending moment may be applied to the glass substrate 100 on one or both sides of the vent thereby mechanically separating the glass substrate along the scribe line 109.

In one embodiment, the system may be operated such that the beam spot is advanced along the desired line of separation starting prior to the first edge and after the second edge such that the beam spot traverses both the first and second edges. To create a scribe line that is positioned only between the defect and the termination point and does not extend from the first edge to the second edge, the cooling jet may be operated in an “off” mode when the beam spot generated by the laser beam is incident on the glass substrate prior to the defect and after the termination location, and operated in an “on” mode when the beam spot is incident on the glass substrate on the defect and between the defect and the termination location. Therefore, the cooling spot is only provided on the surface of the glass substrate from the defect to the termination location. Operating the cooling jet in this manner prevents quenching of the glass substrate prior to the defect and after the termination location which thereby prevents a vent from opening in these locations and results in a scribe line that extends from the defect to the termination location.

In another embodiment, the cooling jet may be operated in a continuously on mode such that a cooling spot is provided on the surface of the glass substrate from the first edge to the second edge. In this embodiment, the laser source may be operated at a low power level when the laser beam is incident on the glass substrate prior to the defect and after the termination location, and at a high power level when the laser beam is incident on the glass substrate between the defect and the termination location. The low power level may be an off mode (i.e., zero radiation), or some sufficiently low power level such that the laser beam does not heat the glass substrate to a temperature sufficient to open a vent. The high power level may be a power level that is operable to open a vent as described hereinabove. Operating the laser source in this manner provides for controlled vent propagation between the defect and the termination location and not at the edges of the glass substrate.

Prevention of a vent from extending past the termination location toward the second edge may also be realized by operating the laser source at an increased power level near the terminal termination location so that the vent propagation outruns the translation speed of the glass substrate. In the laser scribing operation, the laser generated vent may typically propagates at the same speed as the relative motion of the laser beam and cooling jet with respect to the glass substrate. However, increasing the lasing power of the laser source may cause the vent to outrun the translation speed of the glass substrate such that the vent propagates into a laser heated region provided by the laser beam spot. When the vent front (i.e., the leading edge of the propagating vent) enters the laser heated region, it becomes quenched by the increased power of the laser source in conjunction with the cooling jet and stops progressing altogether. Therefore, vent propagation may be controllably stopped by increasing the power of the laser source near the terminal location.

Preventing a vent from opening between the first edge and the defect and between the termination location and the second edge may also be realized by translating the glass substrate at a high speed when the laser beam is located between the first edge and the defect and between the termination location and the second edge, and at a low speed when the laser beam is located between the defect and the termination location. The high speed should be a glass translation speed that is fast enough to prevent the opening of a vent while the low speed should be a glass translation speed that is capable of opening a vent to form a scribe line (i.e., scribing speed υ). By speeding up the glass translation before the defect and after the termination point, the scribe line may be formed only between the defect and the termination location.

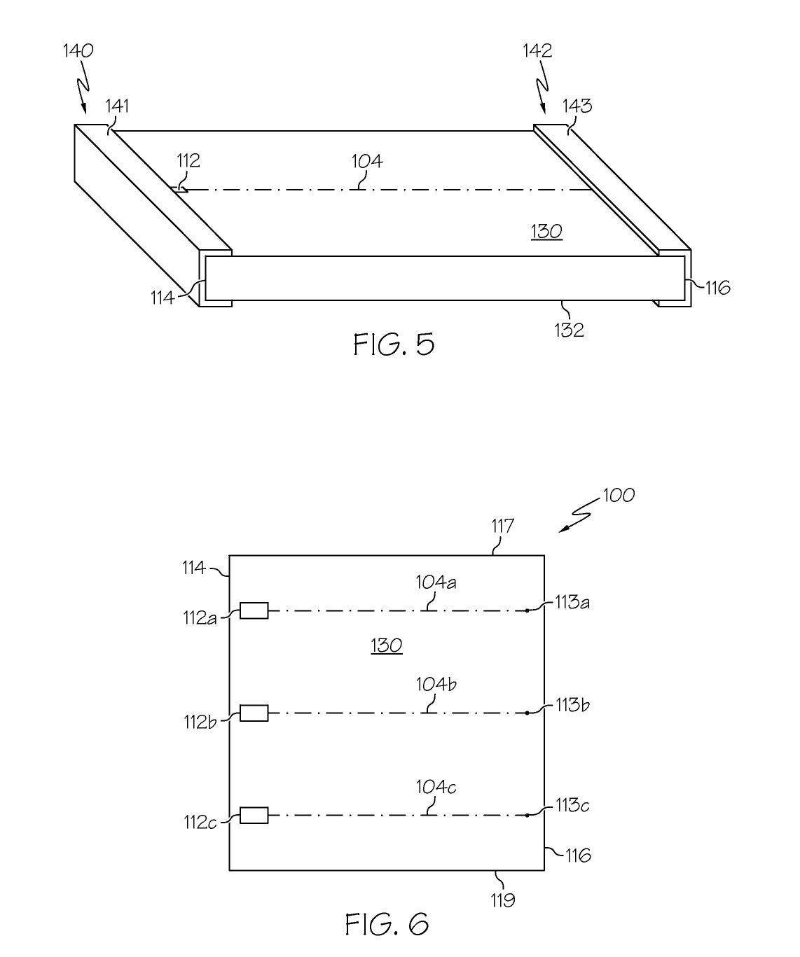

Referring to FIG. 5, embodiments of the methods described herein may also utilize laser shields 140, 142 to prevent the beam spot and cooling spot from reaching the surface of the glass substrate in a first shielded region that extends from the defect 112 to the first edge 114 and the termination location 113 to the second edge 116. The laser shields 140, 142 may comprise a material such as a metal material, for example, capable of preventing laser radiation from entering and heating the glass substrate in the shielded regions. In the embodiment illustrated in FIG. 5, a first laser shield 140 is configured to be applied to the glass substrate 100 at the first edge 114 such that a first shielding surface 141 covers the first shielded region. Similarly, a second laser shield 142 is configured to be applied to the glass substrate 100 at the second edge 116 such that a second shielding surface 143 covers the second shielded region. It should be understood that other laser shield configurations may be utilized. For example, the laser shields may be configured as a flat metal sheet that is attached to the glass substrate 100 (e.g., only the top surface of the glass substrate is shielded at the first edge and the second edge). As the glass substrate is translated with respect to the beam spot and cooling jet, the laser shields 140, 142 prevent the vent from opening in the first and second shielded regions thereby enabling a scribe line that extends from the defect to the termination point.

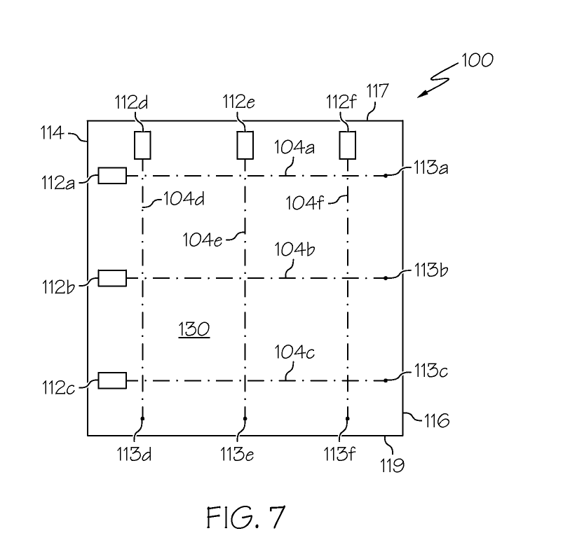

The methods described hereinabove can be used to form one or more vents in glass substrates facilitating the use of the scribe-and-break technique to separate such glass substrates into a plurality of smaller pieces. For example, FIGS. 6 and 7 graphically depict methods for separating a glass substrate 100 into a plurality of pieces using the vent formation methods described herein.

Referring to FIG. 6, a glass substrate 100 is depicted which comprises an upper surface or first surface 130. The glass substrate 100 is separated into a plurality of pieces by introducing a first defect 112a into the surface of the glass substrate 100 on the first surface 130 that is offset from a first edge 114 as described above. The first defect 134 may be formed in the surface of the glass substrate 100 using a mechanical scribe, such as a diamond or carbide point or wheel, or by laser ablation. A plurality of additional defects such as second defect 112b and third defect 112c may also be applied to the first surface 130 to generate additional scribe lines thereby enabling the glass substrate 100 to be separated into a plurality of pieces. Any number of additional defects may be introduced to the first surface 130.

A vent may then be opened in the glass substrate 100 along a first desired line of separation 104a extending through the first defect 112a to a first termination location 113a using one of the vent formation techniques described herein above. For example, in one embodiment, an elliptical beam spot of a CO₂ laser is directed onto the first defect 112a such that the major axis of the elliptical beam spot is substantially aligned on the first desired line of separation 104a. Thereafter, a cooling jet is directed onto the glass substrate such that the cooling spot of the cooling jet is positioned proximate the trailing edge of the beam spot.

The elliptical beam spot and the cooling spot are then directed over the surface of the glass substrate along the first desired line of separation 104a thereby opening a first vent in the glass substrate that extends partially through the thickness of the glass substrate and forms a first scribe line, as described above. In general, the first vent in the glass substrate 100 generally extends through less than a quarter of the thickness h of the glass substrate.

Similarly, a second scribe line is formed along a second desired line of separation 104b starting at the second defect 112b and terminating at a second termination location 113b, and a third scribe line is formed along a third desired line of separation 104c starting at the third defect 112c and terminating at a third termination location 113c, as described above regarding the formation of the first scribe line.

Once the first, second and third scribe lines been formed in the glass substrate 100, the glass substrate may be mechanically separated into a plurality of pieces along the scribe lines by applying a bending moment about each of the scribe lines. For example, once the glass substrate is separated along the first scribe line by applying a bending moment to the glass substrate 100 about the first scribe line, the resulting pieces are further separated into smaller pieces by applying a bending moment about the second scribe and third scribe lines. In this manner, the glass substrate 100 may be divided into four discrete pieces. It should be understood that more or fewer scribe lines may be formed to separate the glass substrate into more or fewer discrete pieces.

Referring now to FIG. 7, additional off-edge defects may be formed on a third edge 117 of the glass substrate to form additional scribe lines that intersect the first, second and third scribe lines described above at intersection points. A fourth defect 112d, fifth defect 112e and sixth defect 112f may be formed that are offset from the third edge 117. As described above, the defects may be formed by mechanical scribe or laser ablation, for example. The defects 112d-112f may be positioned on fourth, fifth and sixth desired lines of separation 104d-f that intersect the first, second and third desired lines of separation 104a-c. Although fourth, fifth and sixth desired lines of separation 104d-f are illustrated as perpendicular to the first, second and third desired lines of separation 104a-c, embodiments are not limited thereto. For example, the desired lines of separation may be angled or curved to create a desired shape of the separated glass pieces. Fourth, fifth and sixth scribe lines may be generated between the fourth, fifth and sixth defects 112d-f and fourth, fifth and sixth termination locations 113a-f, respectively.

In another embodiment, the fourth, fifth and sixth scribe lines may be generated on a second surface 132 of the glass substrate that is opposite from the first surface 130 by creating defects on the second surface 132 and using the vent formation techniques described above. In one embodiment, in order to form the fourth, fifth and sixth scribe lines in the second surface 132 of the glass substrate 100, the glass substrate is flipped over such that the positioning of the first surface 130 and the second surface 132 is reversed (i.e., the second surface 132 is the upper surface and the first surface 130 is the lower surface). In one embodiment flipping the glass substrate is performed manually, such as by a technician or operator. Alternatively, the glass substrate can be flipped using one or more mechanical gripping devices, such as vacuum chucks or similar devices, which adhere to the surface of the glass substrate and facilitates maneuvering the glass substrate to the desired position.

While the embodiments of the methods for forming scribe lines described herein describe the glass substrate as being flipped after the formation of the first, second and third scribe lines, it should be understood that, in alternative embodiments, the glass substrate may remain stationary to form the first, second and third scribe lines on the first side 130 and the fourth, fifth and sixth scribe lines on the second surface 132. For example, the first, second and third scribe lines may be formed in the glass substrate 100 by directing a laser beam and cooling jet onto the glass substrate from above the glass substrate while the fourth, fifth and sixth scribe lines may be formed in the glass substrate 100 by directing a laser beam and cooling jet onto the glass substrate from below the glass substrate. It should be understood that any number of scribe lines may be formed on opposing surfaces in accordance with the methods described herein.

### EXAMPLES

The methods for forming a scribe line partially through a glass substrate that extends from a defect offset from a first edge to a termination location that is offset from a second edge described hereinabove will now be described further with reference to specific examples. In each example, a scribe line comprising a vent extending partially through the thickness of the glass substrate was formed in glass substrate having thicknesses of about 1.1 mm. The laser source was a CO₂ laser operated to provide a laser beam power of about 82 W in the form of an elliptical beam with major axis length of about 35 mm and a minor axis length of about 2 mm on the surface of the glass substrate. The cooling jet was a water jet from a 0.003″ diameter orifice that was impinged on the trailing edge of the elliptical laser beam. The flow rate of the water jet was approximately 7.8 cubic centimeters per minute.

### Example 1

A fusion drawn, ion-exchanged alkali aluminosilicate glass substrate having a center tension of about 18 MPa, a compressive stress of about 750 MPa, and a depth of layer of about 21 μm was separated by the following method. A defect was created mechanically and was offset approximately 6 mm from the first edge of the glass substrate. Metal strips were used as first and second laser shields to shield the first and second edges of the glass substrate where the laser and water jet passes. The shielded regions extended approximately 6 mm from the respective edges. The laser and water jet were operated at all times as the glass substrate was translated at a speed of about 140 mm/s. The glass did not separate and a scribe line was successfully formed between the shielded regions (i.e., between the defect and a termination location).

### Example 2

A fusion drawn, ion-exchanged alkali aluminosilicate glass substrate having the same properties as Example 1 was separated by the following method. A first defect was created by mechanical means on a first edge of the glass substrate. The first defect was offset approximately 8 mm from the first edge. A second defect was created by mechanical means on a second edge of the glass substrate that was adjacent to the first edge. The second defect was offset approximately 8 mm from the second edge. The same process as described in Example 1 was used to generate two separate scribe lines that intersected at a 90° angle. The scribe lines extended between the shielded regions but did not extend to the edges of the glass substrate. The glass did not separate and scribe lines were successfully formed.

### Example 3

A fusion drawn, ion-exchanged alkali aluminosilicate glass substrate having a center tension of about 28 MPa, a compressive stress of about 725 MPa and a depth of layer of about 40 μm was separated by the following method. Two pieces of metal were used as first and second laser shields to shield the glass on both edges of the glass substrate where the laser and water jet passes. The distances of the shielded glass (i.e., shielded regions) to the edges were approximately 6 mm. The laser and water jet were operated at all times as the glass substrate was translated at a speed of about 105 mm/s. A successful laser scribing process was observed. The scribe line extended between the two shielded regions and withstood handling after the scribing process.

It should now be understood that the methods described herein may be used to separate glass substrates such as glass substrates made from borosilicate glasses, as well as glass substrates formed from aluminosilicate glasses including ion-exchange strengthened aluminosilicate glasses. Methods described herein enable glass substrates, particularly strengthened glass substrates, to be separated by a scribe-and-break process wherein a scribe line is formed on a surface of the glass substrate that does not contact an edge of the glass substrate. Glass substrates having scribe lines described herein applied thereto may be separated by an application of force to the glass substrate along the scribe line or lines.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of forming a scribe line in a glass substrate comprising a compressive surface layer and an inner tension layer, the method comprising:
forming a defect through the compressive surface layer to partially expose the inner tension layer, the defect being offset from a first edge of the glass substrate; and
generating a scribe line through the compressive surface layer by translating the glass substrate with respect to a laser beam and a cooling jet, wherein the scribe line is initiated at the defect and is terminated at a termination location along the scribe line that is offset from a second edge of the glass substrate.

2. The method of claim 1 wherein the glass substrate comprises an ion-exchanged glass substrate.

3. The method of claim 1 wherein the scribe line comprises a controlled crack that penetrates partially into the inner tension layer.

4. The method of claim 1 wherein the laser beam is configured to generate an elliptical beam spot having a major axis and a minor axis on the compressive surface layer such that the major axis is aligned with a glass substrate cutting axis.

5. The method of claim 4 wherein the cooling jet is applied to the compressive surface layer within the elliptical beam spot at a trailing edge of the major axis.

6. The method of claim 1 wherein the scribe line is initiated at the defect and terminated at the termination location by:
operating the cooling jet in an off mode when the cooling jet is located prior to the defect;
operating the cooling jet in an on mode when the cooling jet is located between the defect and the termination location; and
operating the cooling jet in the off mode when the cooling jet is located after the termination location.

7. The method of claim 1 wherein the scribe line is initiated at the defect and terminated at the termination location by:
emitting the laser beam at a low power level when the laser beam is located prior to the defect;
emitting the laser beam at a high power level when the laser beam is located between the defect and the termination location; and
emitting the laser beam at the low power level when the laser beam is located after the termination location.

8. The method of claim 1 wherein the scribe line is initiated at the defect and terminated at the termination location by:
translating the glass substrate at a high speed when the laser beam is located prior to the defect and after the termination location; and
translating the glass substrate at a low speed when the laser beam is located between the defect and the termination location.

9. The method of claim 1 further comprising:
applying a first laser shield to a first shielded region of the glass substrate located between the first edge and the defect; and
applying a second laser shield to a second shielded region of the glass substrate located between the second edge and the termination location, wherein the first and second laser shields are operable to prevent the laser beam from being incident on the compressive surface layer in the first and second shielded regions.

10. The method of claim 1 wherein the method further comprises generating an additional scribe line.

11. The method of claim 10 wherein the scribe line and the additional scribe line intersect at an intersection point.

12. A method of forming a scribe line in a glass substrate comprising:
forming a defect on a surface of the glass substrate that is offset from a first edge of the glass substrate; and
generating a scribe line on the surface of the glass substrate between the defect and a termination location that is offset from a second edge of the glass substrate by translating the glass substrate with respect to a laser beam and a cooling jet, wherein:
the laser beam is configured to generate an elliptical beam spot having a major axis and a minor axis on the surface of the glass substrate such that the major axis is aligned with a glass substrate cutting axis; and
the cooling jet is applied to the surface of the glass substrate proximate a trailing edge of the major axis of the elliptical beam spot.

13. The method of claim 12 wherein the scribe line is generated by:
operating the cooling jet in an off mode when the cooling jet is located prior to the defect;
operating the cooling jet in an on mode when the cooling jet is located between the defect and the termination location; and
operating the cooling jet in the off mode when the cooling jet is located after the termination location.

14. The method of claim 12 wherein the scribe line is generated by:
emitting the laser beam at a low power level when the laser beam is located prior to the defect;
emitting the laser beam at a high power level when the laser beam is located between the defect and the termination location; and
emitting the laser beam at the low power level when the laser beam is located after the termination location.

15. The method of claim 12 wherein the scribe line is generated by:
translating the glass substrate at a high speed when the laser beam is located prior to the defect and after the termination location; and
translating the glass substrate at a low speed when the laser beam is located between the defect and the termination location.

16. The method of claim 12 further comprising:
applying a first laser shield to a first shielded region of the glass substrate located between the first edge and the defect; and
applying a second laser shield to a second shielded region of the glass substrate located between the second edge and the termination location, wherein the first and second laser shields are operable to prevent the laser beam from being incident on the surface of the glass substrate in the first and second shielded regions.

17. A method of separating a glass substrate comprising a compressive surface layer and an inner tension layer, the method comprising:
forming a defect through the compressive surface layer to partly expose the inner tension layer, the defect being offset from a first edge of the glass substrate;
applying a first laser shield to a first shielded region of the glass substrate located between the first edge and the defect;
applying a second laser shield to a second shielded region of the glass substrate located between a second edge of the glass substrate and a termination location that is offset from the second edge;
generating a scribe line through the compressive surface layer by translating the glass substrate with respect to a laser beam and a cooling jet, wherein the first and second laser shields are operable to prevent the laser beam from being incident on the compressive surface layer in the first and second shielded regions; and
applying a force to the glass substrate such that the glass substrate separates along the scribe line.

18. The method of claim 17 wherein the scribe line comprises a controlled crack that penetrates partially into the inner tension layer.

19. The method of claim 17 wherein the method further comprises generating an additional scribe line.

20. The method of claim 19 wherein the scribe line and the additional scribe line intersect at an intersection point.
